(19) United States
(12) Patent Application Publication
(10) Pub. No.: US 2007/0050628 A1
(43) Pub. Date: Mar. 1, 2007

(54) Image processing apparatus

(75) Inventor: Kengo Ochi, Tokyo (JP)

Correspondence Address: RABIN & Berdo, PC, 1101 14TH STREET, NW, SUITE 500, WASHINGTON, DC, 20005, US

(73) Assignee: OKI DATA CORPORATION, Tokyo (JP)

(21) Appl. No.: 11/507,612

(22) Filed: Aug. 22, 2006

(30) Foreign Application Priority Data
Aug. 24, 2005 (JP) 2005-242503

(51) Int. Cl. H04L 9/00

(52) U.S. Cl. 713/176

(57) ABSTRACT

An encryption key extracting unit extracts encryption key information from an encryption key sheet on which an encryption key has been printed in a readable format. A key information storing unit stores the extracted encryption key information. An encrypting unit encrypts image data read by a reading unit from a transmission original on the basis of the encryption key information. Processes for encrypting the read image data on the basis of a public key encryption system and transmitting the encrypted data are simplified.

### BACKGROUND OF THE INVENTION

1. Field of the Invention

The invention relates to an image processing apparatus for converting read image information into image data and transmitting the converted image data and, more particularly, to an image processing apparatus for encrypting the image data and transmitting the encrypted image data.

2. Related Background Art

An image processing apparatus connected to a communication network receives transmitting requests from a number of terminal apparatuses connected to the network and transmits image data (for example, refer to JP-A-1999(Heisei-11)-215384). Naturally, a LAN (Local Area Network) is included in the network and, in many cases, a WAN (Wide Area Network) is also included. Therefore, holding of a secrecy of the image data to be transmitted is one of extremely important subjects. To accomplish such a subject, according to the related art, in the case where a secrecy is required for transmission of the image data whose transmission is required, the image data to be transmitted is encrypted by using a public key encryption system. To encrypt the image data to be transmitted, first, the user needs to allow a public key to be preliminarily read into the image processing apparatus by using a terminal apparatus other than the image processing apparatus and processes at the preparation stage are complicated.

It is a problem to be solved that in order to encrypt the image data to be transmitted, first, the user needs to allow the public key to be preliminarily read into the image processing apparatus by using the terminal apparatus other than the image processing apparatus and the processes at the preparation stage are complicated.

### SUMMARY OF THE INVENTION

It is an object of the invention to provide an image processing apparatus for converting read image information into image data and transmitting the converted image data, wherein the image data is encrypted and transmitted.

According to the present invention, there is provided an image processing apparatus having an image reading unit which reads image information from a document to obtain image data, comprising:

an encryption key extracting unit which extracts encryption key information from the document having the encryption key information;

a key information storing unit which stores the encryption key information extracted by the encryption key extracting unit; and

an encrypting unit which encrypts the image data on the basis of the encryption key information.

Moreover, in the image processing apparatus, the encryption key information may be key information based on a public key encryption system.

Further, according to the present invention, there is also provided an image processing apparatus having an image reading unit which reads image information from a document to obtain image data, comprising:

a transmission destination instructing unit which instructs a transmission destination of the image information;

an encryption key obtaining unit which obtains encryption key information corresponding to the transmission destination of the image data instructed by the transmission destination instructing unit from an outside of the apparatus; and

an encrypting unit which encrypts the image data on the basis of the encryption key information obtained by the encryption key obtaining unit.

Moreover, the image processing apparatus may further comprise an E-mail converting unit which converts the image data encrypted by the encrypting unit into an E-mail format.

Moreover, in the image processing apparatus, the encryption key information may be key information based on a public key encryption system.

Moreover, the image processing apparatus may further comprise a communicating unit connected to a network, and wherein the encryption key obtaining unit obtains the encryption key information through the communicating unit. Then, the encryption key obtaining unit may obtain the encryption key information on the basis of a TCP/IP protocol. Further, the encryption key obtaining unit may obtain the encryption key information on the basis of an HTTP protocol.

Furthermore, according to the present invention, there is also provided an image processing apparatus having an image reading unit which reads image information from a document to obtain image data, comprising:

an encryption key forming unit which forms first encryption key information to encrypt the image data;

a first encrypting unit which encrypts the image data on the basis of the first encryption key information;

a transmission destination instructing unit which instructs a transmission destination of the image data;

an encryption key obtaining unit which obtains second encryption key information corresponding to the transmission destination of the image data instructed by the transmission destination instructing unit; and

a second encrypting unit which encrypts the first encryption key information on the basis of the second encryption key information.

Moreover, in the image processing apparatus, the first encrypting unit may execute an encrypting process according to a common key encryption system and the second encrypting unit may execute an encrypting process according to a public key encryption system.

Moreover, in the image processing apparatus, the first encryption key information encrypted by the second encrypting unit may be transmitted to the transmission destination of the image data.

Moreover, the image processing apparatus may further comprise an E-mail converting unit which converts the image data encrypted by the first encrypting unit into an E-mail format.

Moreover, the image processing apparatus may further comprise a communicating unit connected to a network, and wherein the encryption key obtaining unit obtains the second encryption key information through the communicating unit.

Moreover, in the image processing apparatus, the encryption key obtaining unit may obtain the second encryption key information from the transmission destination of the image data.

Moreover, in the image processing apparatus, the encryption key obtaining unit may obtain the second encryption key information on the basis of a TCP/IP protocol. Further, the encryption key obtaining unit may obtain the second encryption key information on the basis of an HTTP protocol.

Moreover, in the image processing apparatus, the encryption key forming unit may form the first encryption key information on the basis of pseudo random numbers.

According to the first invention, the encryption key extracting unit is provided for a scanner apparatus and the encryption key is automatically extracted from an encryption key sheet on which the encryption key has been printed in a format which can be read by the scanner apparatus. Therefore, the preparation stage is completed by a series of operations together with the operation for reading the transmission original by the scanner apparatus and such an effect that the processes are extremely simplified is obtained. According to the second invention, the encryption key obtaining unit is provided for the scanner apparatus and when the operator designates the transmission destination, the scanner apparatus automatically obtains the encryption key from the encryption key storing server in which the encryption keys have been registered and can use it for the encryption of the transmission original. Therefore, such an effect that the processes are extremely simplified is obtained.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a block diagram showing a construction of an image processing apparatus of an embodiment 1;

FIG. 2 is a constructional diagram of an image processing system including a scanner apparatus in the embodiment 1;

FIG. 3 is a flowchart for explaining the operation of the scanner apparatus in the embodiment 1;

FIG. 4 is an explanatory diagram of an encryption key sheet;

FIG. 5 is an explanatory diagram of an operation panel of the scanner apparatus in the embodiment 1;

FIG. 6 is a block diagram showing a construction of an image processing apparatus of an embodiment 2;

FIG. 7 is a constructional diagram of an image processing system including a scanner apparatus in the embodiment 2;

FIG. 8 is a flowchart for explaining the operation of the scanner apparatus in the embodiment 2;

FIG. 9 is an explanatory diagram of an operation panel of the scanner apparatus in the embodiment 2; and

FIG. 10 is a block diagram showing a construction of an image processing apparatus according to a modification of the embodiment 2.

### DETAILED DESCRIPTION OF THE PREFERRED EMBODIMENTS

An encryption key is used as a public key in the public key encryption system. Prior to requesting image data, the encryption key is transmitted by E-mail to a transmitting source (or common institution) from a requesting source. The requesting source of the image data secretly holds a secret key.

[Embodiment 1]

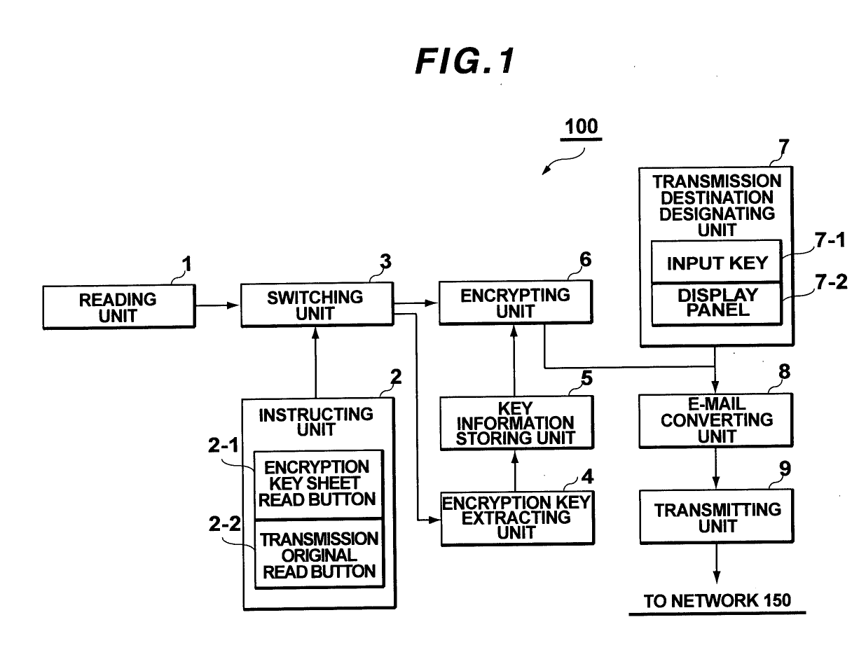

FIG. 1 is a block diagram showing a construction of an image processing apparatus of an embodiment 1.

As shown in the diagram, a scanner apparatus 100 of the embodiment 1 has: a reading unit 1; an instructing unit 2; a switching unit 3; an encryption key extracting unit 4; a key information storing unit 5; an encrypting unit 6; a transmission destination designating unit 7; an E-mail converting unit 8; and a transmitting unit 9.

The reading unit 1 is a portion for reading image information from a document (original) and converting it into image data. For example, the reading unit 1 is constructed by a line sensor and its moving portion and is a portion for converting the read image information into the image data and transmitting the converted image data to the switching unit 3. Although an optical sensor is ordinarily used, there is no need to particularly limit a reading system.

The instructing unit 2 has an encryption key sheet read button 2-1 and a transmission original read button 2-2 and is a portion for notifying the switching unit 3 of a kind of original which is designated by the operator. The encryption sheet mentioned here denotes the original on which the encryption key received from the requesting source of the image data has been printed. Such an encryption sheet is hereinafter referred to as an encryption key sheet. The transmission original is an original medium (i.e. a document) on which the image information serving as a foundation of the image data which is encrypted and transmitted has been written. The encryption key printed on the encryption key sheet has been printed as, for example, a bar code and has a format which can be read by the reading unit 1. It is unnecessary to limit the format of the encryption key to the bar code but a format in which the encryption key is expressed as a character train or a format in which the encryption key has been encoded by a special method may be used.

The switching unit 3 is a portion for switching the transmission destination of the image data which is received from the reading unit 1 in accordance with the kind of original notified by the instructing unit 2. If the instructing unit 2 notifies the switching unit 3 that the original to be read is the encryption key sheet, the switching unit 3 switches the transmission destination of the image data to the encryption key extracting unit 4. If the instructing unit 2 notifies the switching unit 3 that the original to be read is the transmission original, the switching unit 3 switches the transmission destination of the image data to the encrypting unit 6.

When the image data of the encryption key sheet is sent from the switching unit 3, the encryption key extracting unit 4 extracts the encryption key to encrypt the transmission original from the image data. The extracted encryption key is converted into a numerical value so that the encryption key can be used in the encrypting unit 6 and the converted numerical value is sent to the key information storing unit 5.

The key information storing unit 5 is a memory to store the encryption key sent from the encryption key extracting unit 4.

When the image data of the transmission original is sent from the switching unit 3, the encrypting unit 6 obtains the encryption key from the key information storing unit 5, encrypts the image data of the transmission original by using the encryption key, and sends the encrypted image data to the E-mail converting unit 8.

The transmission destination designating unit 7 has an input key 7-1 and a display panel 7-2 and is a portion for designating the transmission destination of the image data encrypted by the encrypting unit 6. The operator inputs an E-mail address of the transmission destination by using the input key 7-1. The E-mail address is displayed to the display panel 7-2.

The E-mail converting unit 8 is a portion for obtaining the E-mail address of the transmission destination from the transmission destination designating unit 7, forming E-mail by setting the E-mail address to the transmission destination and setting the encrypted image data (of the transmission original) received from the encrypting unit 6 to an attached file, and sending the formed E-mail to the transmitting unit 9.

The transmitting unit 9 is a portion for transmitting the E-mail formed by the E-mail converting unit 8 to an E-mail server (which will be explained hereinafter). An SMTP (Simple Mail Transfer Protocol) is ordinarily used as a communication protocol to transmit the E-mail to the E-mail server. Naturally, there is no need to limit the communication protocol to the SMTP.

A construction of an image processing system including the scanner apparatus 100 in the foregoing embodiment 1 will be described hereinbelow.

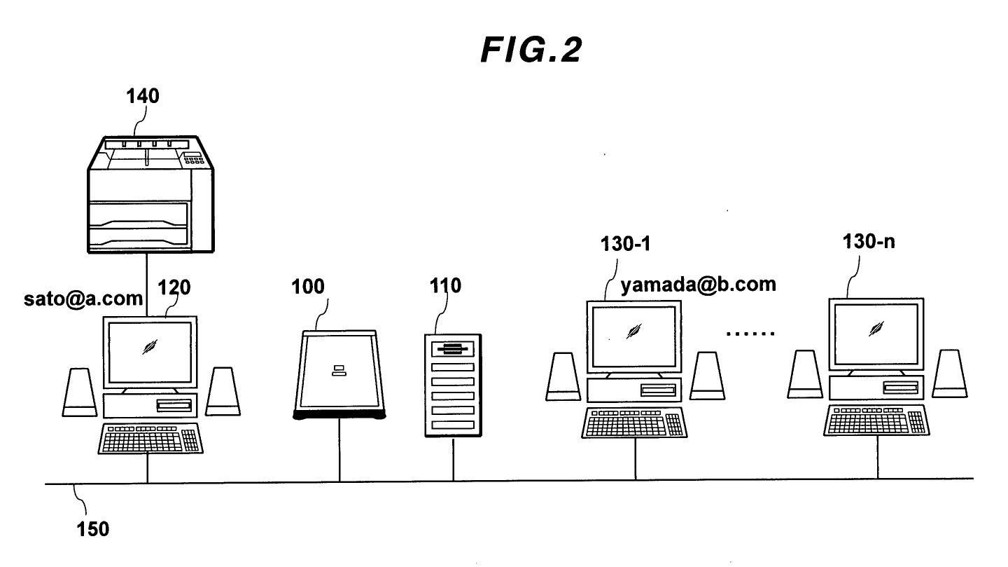

FIG. 2 is a constructional diagram of the image processing system including the scanner apparatus in the embodiment 1.

As shown in the diagram, the image processing system is constructed by communication-connecting the following component elements to a network 150: the scanner apparatus 100; an E-mail server apparatus 110; a transmitting side terminal apparatus 120; (a plurality of) receiving side terminal apparatuses 130 (130-1 to 130-n); and a printer apparatus 140.

In the diagram, the scanner apparatus 100 is a scanner apparatus in the above embodiment 1. Each of the receiving side terminal apparatuses 130 is a terminal apparatus (ordinarily, personal computer) for receiving the encrypted image data which is transmitted from the scanner apparatus 100. The receiving side terminal apparatus 130 is an apparatus for preliminarily transmitting its own public key (encryption key) to the transmitting side terminal apparatus 120 by E-mail (the public key may be also transmitted just before the start of the operation). The E-mail server apparatus 110 is a server to store the E-mail which is transmitted from the scanner apparatus 100. The transmitting side terminal apparatus 120 is a terminal apparatus (ordinarily, personal computer) on the transmitting side for holding the encryption key of the receiving side terminal apparatus 130, converting the encryption key into the image data, and sending the converted image data to the printer apparatus 140. The printer apparatus 140 is an apparatus for receiving the encryption key converted into the image data from the transmitting side terminal apparatus 120 and forming the encryption key sheet. The transmitting side terminal apparatus 120 and the printer apparatus 140 are generally connected by a USB (Universal Serial Bus). The network 150 is generally a communication network including the LAN or WAN.

The operation of the embodiment 1 will be described hereinbelow. In the description of the operation, it is assumed that in the image processing system including the scanner apparatus in FIG. 2, the encrypted image data (of the transmission image) is transmitted from the scanner apparatus 100 to the receiving side terminal apparatus 130-1 on the basis of the public key encryption system.

There is an RSA (Rivest, Shamir, Adleman) or the like as an example of the public key encryption system.

Two keys are used in the public key encryption system. One of them is a secret key and the other is a public key. Generally, the public key has been registered in a public institution or the like which can be used by everybody. The user himself secretly manages the secret key. Therefore, the transmitting side obtains the public key corresponding to the receiving side from a number of registered public keys, encrypts the image data (of the transmission image) by using the obtained public key, and sends the encrypted image data to the network. The transmitted encrypted image data can be decrypted only by the receiving side having the secret key. In the embodiment, it is assumed that the receiving side terminal apparatus 130-1 sends its own public key to the transmitting side terminal apparatus 120 by E-mail (since the key is the public key, there is no need to keep a secrecy) and the scanner apparatus 100 encrypts the image data (of the transmission image) by using this public key and sends the encrypted image data to the receiving side terminal apparatus 130-1.

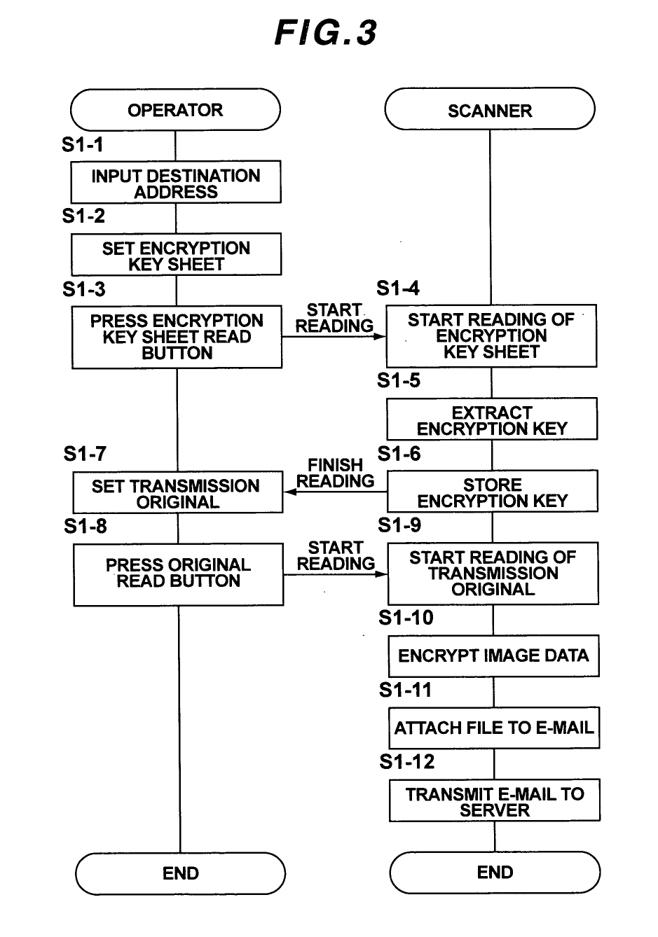

FIG. 3 is a flowchart for explaining the operation of the scanner apparatus in the embodiment 1.

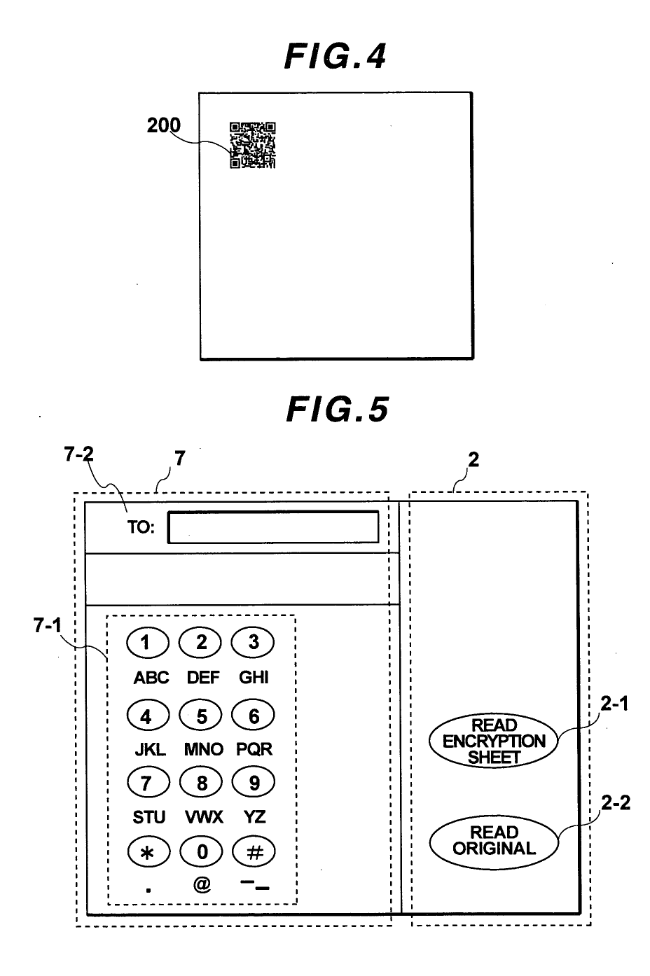

FIG. 4 is an explanatory diagram of the encryption key sheet.

FIG. 5 is an explanatory diagram of an operation panel of the scanner apparatus in the embodiment 1.

The operation of the scanner apparatus in the embodiment 1 will now be described in order of processing steps S1-1 to S1-12 in FIG. 3. In the description of the operation, FIGS. 4 and 5 are properly used. In the following operation explanation, the following prerequisite conditions are set.
1) The public key (encryption key) has already been sent by E-mail from the receiving side terminal apparatus 130-1 (FIG. 2) to the transmitting side terminal apparatus 120 (FIG. 2).
2) The operator has already obtained the encryption key sheet (FIG. 4) on which the public key (encryption key) had been printed by using the printer apparatus 140 (FIG. 2).
   Step S1-1:

The operator inputs an address “yamada@b.com” (FIG. 2) of the transmission destination into the transmission destination designating unit 7 (FIGS. 1 and 5) by using the input key 7-1 (FIGS. 1 and 5) of the scanner apparatus 100 (FIG. 1). This address is displayed on the display panel 7-2 (FIGS. 1 and 5).

Step S1-2:

The operator sets the encryption key sheet (FIG. 4) into the reading unit 1 (FIG. 1) of the scanner apparatus 100 (FIG. 1).

Step S1-3:

The operator presses the encryption key sheet read button 2-1 (FIGS. 1 and 5) of the scanner apparatus 100 (FIG. 1). Thus, the switching unit 3 (FIG. 1) switches the outputs so as to transmit the image data to the encryption key extracting unit 4 (FIG. 1).

Step S1-4:

The reading unit 1 (FIG. 1) starts the operation to read the image information from the encryption key sheet (FIG. 4).

Step S1-5:

The encryption key extracting unit 4 (FIG. 1) receives the image data from the switching unit 3 (FIG. 1) and extracts the encryption key.

Step S1-6:

The extracted encryption key is stored into the key information storing unit 5 (FIG. 1).

Step S1-7:

The operator sets the transmission original to be encrypted and transmitted into the reading unit 1 (FIG. 1) of the scanner apparatus 100 (FIG. 1).

Step S1-8:

The operator presses the transmission original read button 2-2 (FIGS. 1 and 5) of the scanner apparatus 100 (FIG. 1). Thus, the switching unit 3 (FIG. 1) switches the output so as to transmit the image data to the encrypting unit 6 (FIG. 1).

Step S1-9:

The reading unit 1 (FIG. 1) starts the operation to read the image information from the transmission original.

Step S-10:

The encrypting unit 6 (FIG. 1) obtains the encryption key from the key information storing unit 5 (FIG. 1) and encrypts the image data read out of the transmission original.

Step S1-11:

The E-mail converting unit 8 (FIG. 1) obtains the E-mail address of the transmission destination inputted by the operator from the transmission destination designating unit 7 (FIG. 1) in step S1-1, forms E-mail by setting the E-mail address to the transmission destination and setting the encrypted image data of the transmission original received from the encrypting unit 6 (FIG. 1) to an attached file, and sends the formed E-mail to the transmitting unit 9 (FIG. 1).

Step S1-12:

The E-mail formed by the E-mail converting unit 8 (FIG. 1) is sent to the E-mail server apparatus 110 (FIG. 2) from the transmitting unit 9 (FIG. 1) through the network 150 (FIG. 2) on the basis of a predetermined protocol, and the processing flow is finished. The SMTP is ordinarily used as a predetermined protocol. Naturally, there is no need to limit the predetermined protocol to the SMTP.

After that, the receiver operates the receiving side terminal apparatus 130-1 (FIG. 2) and obtains the E-mail to himself from the E-mail server apparatus 110 (FIG. 2) through the network 150 (FIG. 2) on the basis of a predetermined protocol. If the encrypted E-mail exists in the received E-mail, the receiver decrypts the attached file by using his own decryption key (secret key) on the receiving side terminal apparatus 130 (FIG. 2) and browses it. A POP (Post Office Protocol) is ordinarily used as a predetermined protocol. Naturally, there is no need to limit the predetermined protocol to the POP.

As described above, in the case where the image data read out of the transmission original by the scanner apparatus is encrypted on the basis of the public key encryption system and transmitted, according to the embodiment, by providing the encryption key extracting unit for the scanner apparatus, the encryption key can be extracted from the encryption key sheet on which the encryption key has been printed in the format which can be read by the scanner apparatus. Therefore, the preparation stage is completed by a series of operations together with the operation for reading the transmission original by the scanner apparatus and such an effect that the processes are extremely simplified is obtained.

[Embodiment 2]

According to the embodiment 1, the encryption key is extracted from the encryption key sheet before the encrypting process (ordinarily, just before) and used for the encryption of the transmission original. However, in the embodiment 2, it is assumed that an encryption key obtaining unit is provided for the scanner apparatus and when the operator designates the transmission destination from the encryption key storing server in which the public keys (encryption keys) have previously been registered before the encrypting process, the encryption key obtaining unit automatically obtains the encryption key and uses it for the encryption of the transmission original.

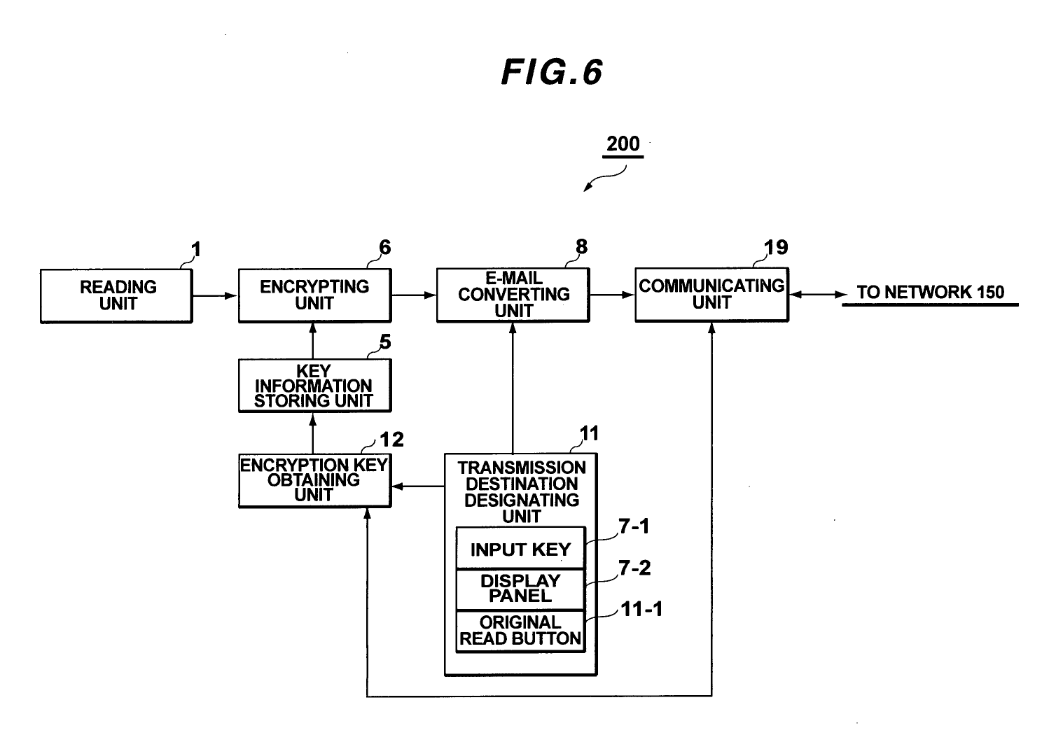

FIG. 6 is a block diagram showing a construction of an image processing apparatus of the embodiment 2.

As shown in the diagram, a scanner apparatus 200 in the embodiment 2 has: the reading unit 1; the key information storing unit 5; the encrypting unit 6; the E-mail converting unit 8; a communicating unit 19; a transmission destination designating unit 11; and an encryption key obtaining unit 12. Only portions different from those in the embodiment 1 will be described in detail hereinbelow. The portions similar to those in the embodiment 1 are designated by the same reference numerals as those in the embodiment 1 and their explanation is omitted.

The transmission destination designating unit 11 has the input key 7-1, the display panel 7-2, and an original read button 11-1 and is a portion for designating the transmission destination of the image data encrypted by the encrypting unit 6. The operator inputs the E-mail address of the transmission destination by using the input key 7-1. The E-mail address is displayed to the display panel 7-2.

Further, by pressing the original read button 11-1 after the operator inputted the E-mail address of the transmission destination, the series of operations is started.

When the operator presses the original read button 11-1, the encryption key obtaining unit 12 transmits the E-mail address of the transmission destination to an encryption key storing server apparatus 240 (which will be explained hereinafter) through the communicating unit 19 and the network 150, inquires of the encryption key storing server apparatus 240 (which will be explained hereinafter) about the public key of the transmission destination which has been registered and stores the obtained public key into the key information storing unit 5. An HTTP (Hyper Text Transfer Protocol) is ordinarily used for such an inquiry. There is no need to limit the protocol to the HTTP. For example, an FTP (File Transfer Protocol) may be also used.

A construction of an image processing system including the scanner apparatus 200 in the embodiment 2 described above will be described hereinbelow.

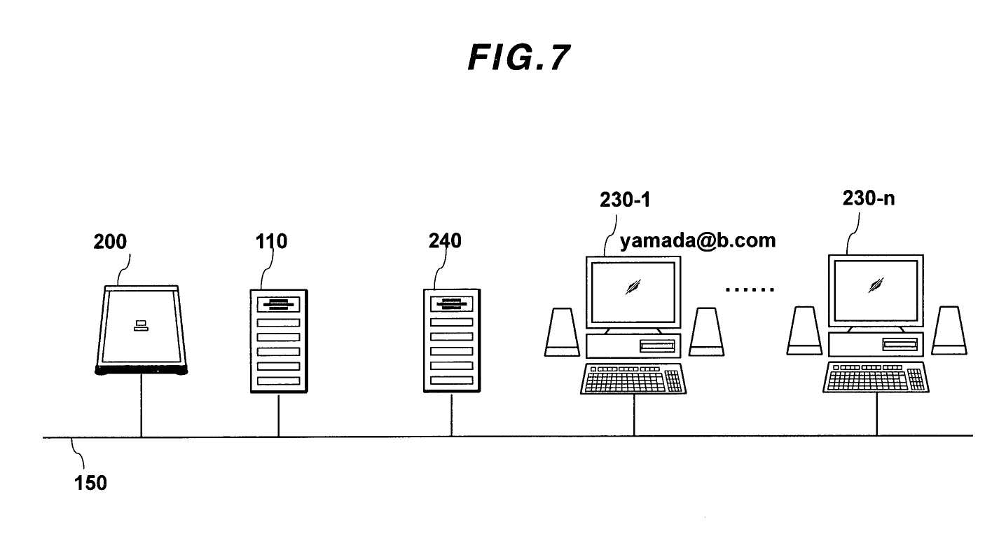

FIG. 7 is a constructional diagram of the image processing system including the scanner apparatus in the embodiment 2.

As shown in the diagram, the image processing system is constructed by communication-connecting the following component elements to the network 150: the scanner apparatus 200; the E-mail server apparatus 110; the encryption key storing server apparatus 240; and (a plurality of) receiving side terminal apparatuses 230 (230-1 to 230-n).

In the diagram, the scanner apparatus 200 is a scanner apparatus in the above embodiment 2. Each of the receiving side terminal apparatuses 230 is a terminal apparatus (ordinarily, personal computer) for receiving the encrypted transmission image from the scanner apparatus 200. The scanner apparatus 200 is an apparatus for preliminarily registering its own public key (encryption key) to the encryption key storing server apparatus 240. The server apparatus 240 has an HTTP server function, can further execute a CGI (Common Gateway Interface) program (Perl or the like), and realizes the function of transmitting the public key by the CGI program. The E-mail server apparatus 110 is a server to store the E-mail which is transmitted from the scanner apparatus 200. The encryption key storing server apparatus 240 is a server to receive the registration of the public keys from the receiving side terminal apparatuses 230-1 to 230-n and store them. When an inquiry about the public key is received from the scanner apparatus 200, the server apparatus 240 searches for the relevant public key and transmits the detected public key to the scanner apparatus 200. The network 150 is generally a communication network including the LAN or WAN.

The operation of the embodiment 2 will be described hereinbelow.

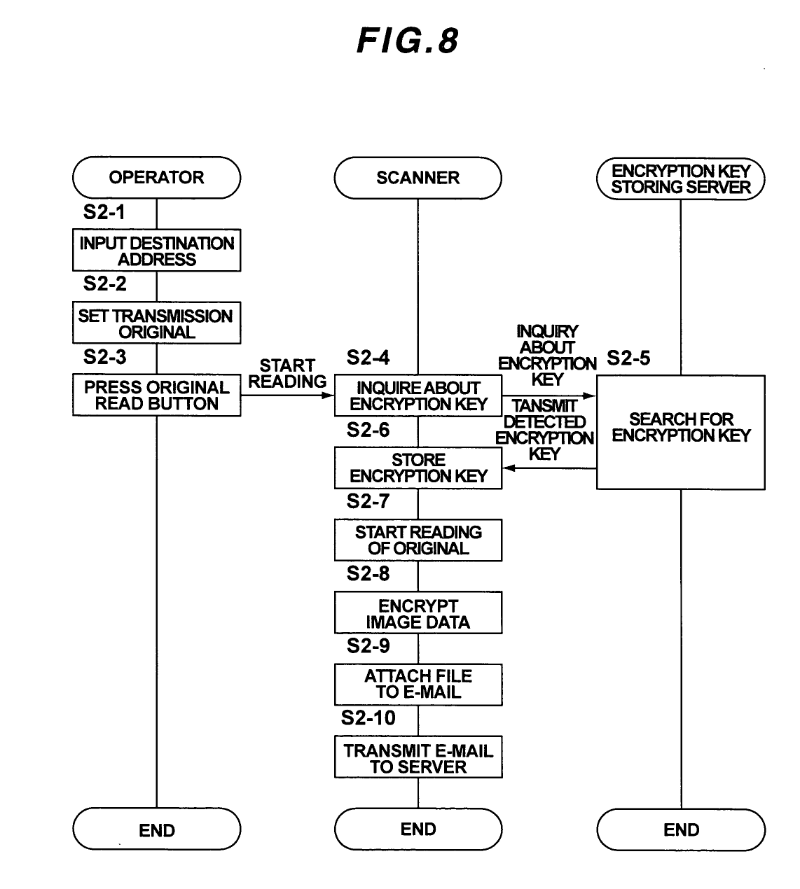

FIG. 8 is a flowchart for explaining the operation of the scanner apparatus in the embodiment 2.

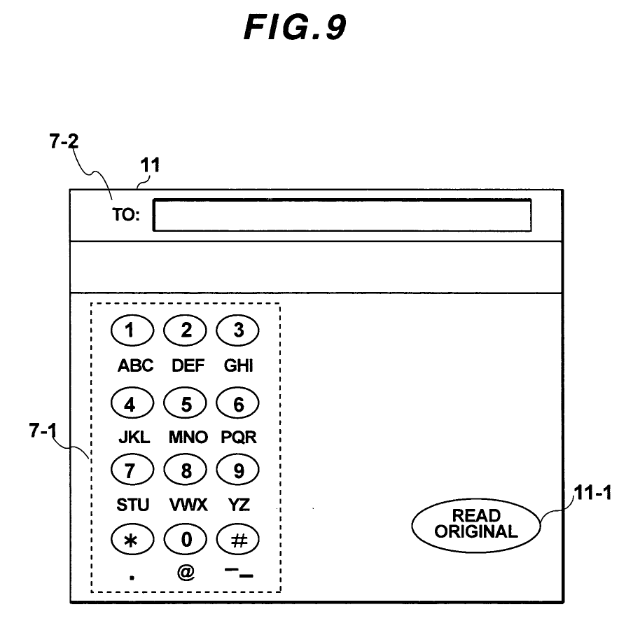

FIG. 9 is an explanatory diagram of an operation panel of the scanner apparatus in the embodiment 2.

The operation of the scanner apparatus in the embodiment 2 will now be described in order of processing steps S2-1 to S2-10 in FIG. 8. In the description of the operation, FIG. 9 is properly used. In the following operation explanation, the following prerequisite condition is set:
1) The public key has already been registered into the encryption key storing server apparatus 240 (FIG. 7) by E-mail from the receiving side terminal apparatus 230-1 (FIG. 7).
   Step S2-1:

The operator inputs the address “yamada@b.com” (FIG. 7) of the transmission destination into the transmission destination designating unit 11 (FIGS. 6 and 9) by using the input key 7-1 (FIGS. 6 and 9) of the scanner apparatus 200 (FIG. 6). This address is displayed on the display panel 7-2 (FIGS. 6 and 9).

Step S2-2:

The operator sets the transmission original to be encrypted and transmitted into the reading unit 1 (FIG. 6) of the scanner apparatus 200 (FIG. 6).

Step S2-3:

The operator presses the transmission original read button 11-1 (FIGS. 6 and 9) of the scanner apparatus 200 (FIG. 6).

Step S2-4:

When the operator presses the transmission original read button 11-1 (FIGS. 6 and 9), the encryption key obtaining unit 12 (FIG. 6) transmits the E-mail address of the transmission destination to the encryption key storing server apparatus 240 (FIG. 7) through the communicating unit 19 (FIG. 6) and the network 150 (FIG. 6) and inquires of the encryption key storing server apparatus 240 (FIG. 7) about the public key of the transmission destination which has been registered by, ordinarily, the HTTP. The HTTP will now be described.

For example, the following signals are sent from the scanner apparatus 200 (FIG. 6) to the encryption key storing server apparatus 240 (FIG. 7).
POST http://key-server.com/key.cgi?key=yamada@b.com HTTP-/1.1
user-Agent:Scan-Device
Host:scanner.a.com

A row starting with “POST” shows that its HTTP header is a POST method to a URL
“http://key-server.com/key.cgi?key=yamada@b.com”and shows that a version of the HTTP which is used is equal to 1.1. The URL
“http://key-server.com/key.cgi?key=yamada@b.com”shows that the address “yamada@b.com” of the transmission destination of the image data has been given as a value of a key parameter to a CGI “key.cgi” of the encryption key storing server apparatus 240 (FIG. 7) having a domain name “key-server.com”.

A row starting with “user-Agent” shows a name of an application transmitted by the HTTP header. In this example, “Scan-Device” is used as a name of the scanner. A row starting with “Host” shows a domain name of an apparatus which made the HTTP header. In this example, the address “yamada@b.com” of the transmission destination of the image data is handed as a key parameter to the CGI “key.cgi” of the encryption key storing server apparatus 240 “http://key-server.com” (FIG. 7) and the public key of “key.cgi?key =yamada@b.com” is requested.

Step S2-5:

The encryption key storing server apparatus 240 (FIG. 7) searches for the public key stored in the server with reference to the E-mail address received by the key parameter and transmits the detected public key to the scanner apparatus 200 (FIG. 6).

Step S2-6:

The encryption key obtaining unit 12 (FIG. 6) stores the received encryption key into the key information storing unit 5 (FIG. 6).

Step S2-7:

The reading unit 1 (FIG. 6) starts the operation to read the image information from the transmission original.

Step S2-8:

The encrypting unit 6 (FIG. 6) obtains the encryption key from the key information storing unit 5 (FIG. 6) and encrypts the image data read out of the transmission original.

Step S2-9:

The E-mail converting unit 8 (FIG. 6) obtains the E-mail address of the transmission destination inputted by the operator in step S2-1 from the transmission destination designating unit 11 (FIG. 6), forms the E-mail by setting the E-mail address to the transmission destination and setting the encrypted image data of the transmission original received from the encrypting unit 6 (FIG. 6) to an attached file, and sends the formed E-mail to the communicating unit 19 (FIG. 6).

Step S2-10:

The E-mail formed by the E-mail converting unit 8 (FIG. 6) is sent to the E-mail server apparatus 110 (FIG. 7) from the communicating unit 19 (FIG. 6) through the network 150 (FIG. 7) on the basis of a predetermined protocol, and the processing flow is finished. The SMTP is ordinarily used as a predetermined protocol. Naturally, there is no need to limit the predetermined protocol to the SMTP.

As described above, in the case where the image data read out of the transmission original by the scanner apparatus is encrypted on the basis of the public key encryption system and transmitted, according to the embodiment, by providing the encryption key obtaining unit for the scanner apparatus, when the operator designates the transmission destination, prior to the encrypting process, the scanner apparatus automatically obtains the public key from the encryption key storing server apparatus in which the public keys have previously been registered and can use it for the encryption of the transmission original. Therefore, such an effect that the processes are extremely simplified is obtained.

Although the case where the invention is applied to the scanner apparatus has been described above, the invention is not limited to such an example. That is, the invention can be also applied to a facsimile apparatus, a copying apparatus, and the like.

The public key has been obtained and the image data has been encrypted by the public key encryption system by using the obtained public key in the embodiment 2. However, a secrecy of the image data can be also realized by the following method. That is,

a common key encryption system (DES, triple DES, etc.) is used as an encryption system of the image data,

a common key used in the common key encryption is encrypted by the public key encryption system by using the public key obtained from the outside, and

the image data encrypted by the common key encryption system and the common key encrypted by the public key encryption system are transmitted to the partner destination.

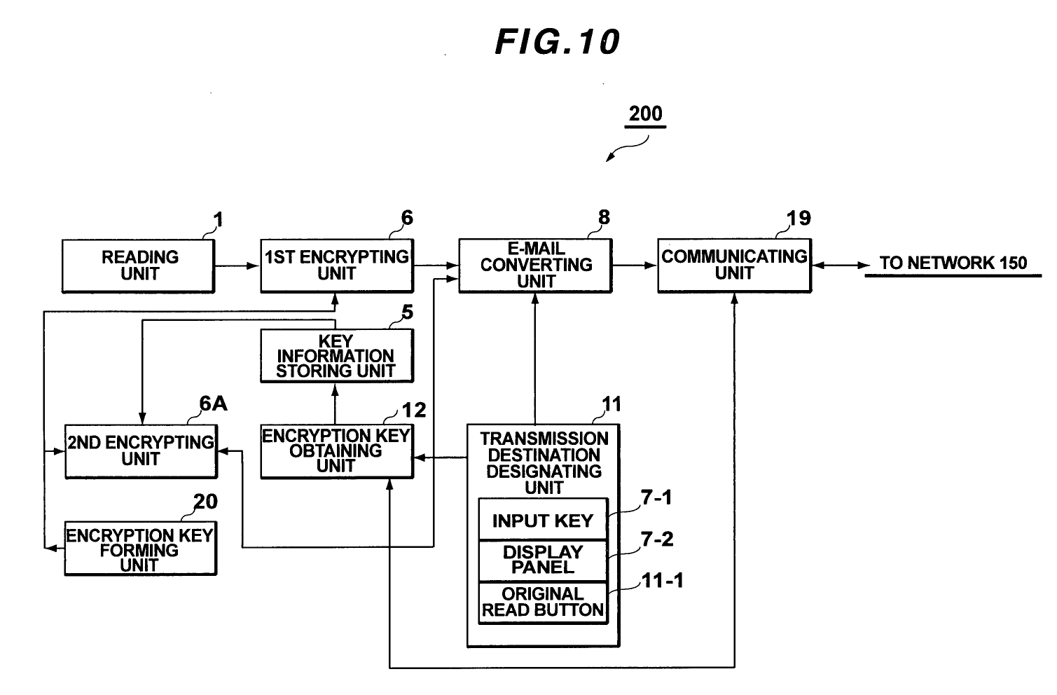

A procedure in this case is as follows (refer to FIG. 10).

In the scanner apparatus,
S1: The common key necessary for the encryption of the common key encryption system is formed by itself by pseudo random numbers or the like.

(Encryption key forming unit 20)
S2: The image data is encrypted by the common key encryption system by using the common key.

(First encrypting unit 6)
S3: The public key corresponding to the address of the transmission destination of the image data is obtained from the encryption key storing server.
S4: The common key used in the common key encryption system is encrypted by the public key encryption system by using the public key obtained from the server.

(Second encrypting unit 6A)
S5: The E-mail is formed by using the image data encrypted by the common key encryption system and the common key encrypted by the public key encryption system as an attached file of the E-mail and the formed E-mail is transmitted through the communicating unit.

In the receiving terminal,
S6: The image data encrypted by the common key encryption system and the common key encrypted by the public key encryption system are extracted from the received E-mail.
S7: The common key encrypted by the public key encryption system is decrypted by the secret key.
S8: The image data encrypted by the common key encryption system is decrypted by using the decrypted common key.

With respect to other points, operations similar to those in the embodiment 2 are executed.

Generally, in the encryption/decryption of the public key encryption system (RSA or the like), a processing speed is slower than that of the common key encryption system (DES, triple DES, etc.) (processes are complicated).

Therefore, as mentioned above, by encrypting the image data by using the common key encryption system and encrypting the common key used for the encryption of the image data by the public key encryption system, the encryption communication of the high secrecy and the high processing speed can be realized.

Although the public key has been obtained from the public key server in the embodiment 2 and its modification, if the terminal apparatus of the transmission destination has the transmitting function of the public key corresponding to the public key encryption system, the public key may be directly obtained from the transmission destination. In this case, the public key can be also obtained on the basis of the TCP/IP protocol.

Although the image information and the common key have been transmitted by using the E-mail protocol in the embodiment 2 and its modification, the image data can be also transmitted to the partner destination by using the FTP protocol, the HTTP protocol, or the TCP/IP protocol as an upper protocol of them.

In the case of the FTP protocol, the image processing apparatus transmits the image information and the encrypted common key to an external FTP server, and

the receiving terminal downloads the image information and the encrypted common key from the FTP server, so that the invention can be embodied.

In the case of the HTTP protocol, for example, by constructing in such a manner that the HTTP server function is provided for the image processing apparatus, on the receiving terminal side, the image information and the encrypted common key are received by the HTTP protocol, the invention can be embodied.

In the case of the TCP/IP protocol, by providing the TWAIN (Tool Without An Interesting Name) driver or the like for the receiving terminal side and transmitting the image information to the TWAIN driver by the TCP/IP protocol, the invention can be embodied. The encrypted common key is transmitted at the TCP/IP protocol level.

It should be understood by those skilled in-the art that various modifications, combinations, sub-combinations and alterations may occur depending on design requirements and other factors insofar as they are within the scope of the appended claims or the equivalents thereof.

What is claimed is:

1. An image processing apparatus having an image reading unit which reads image information from a document to obtain image data, comprising:
an encryption key extracting unit which extracts encryption key information from said document having said encryption key information;
a key information storing unit which stores said encryption key information extracted by said encryption key extracting unit; and
an encrypting unit which encrypts said image data on the basis of said encryption key information.

2. The image processing apparatus according to claim 1, wherein said encryption key information is key information based on a public key encryption system.

3. An image processing apparatus having an image reading unit which reads image information from a document to obtain image data, comprising:
a transmission destination instructing unit which instructs a transmission destination of said image information;
an encryption key obtaining unit which obtains encryption key information corresponding to the transmission destination of said image data instructed by said transmission destination instructing unit from an outside of the apparatus; and
an encrypting unit which encrypts said image data on the basis of said encryption key information obtained by said encryption key obtaining unit.

4. The image processing apparatus according to claim 3, further comprising an E-mail converting unit which converts the image data encrypted by said encrypting unit into an E-mail format.

5. The image processing apparatus according to claim 3, wherein said encryption key information is key information based on a public key encryption system.

6. The image processing apparatus according to claim 3, further comprising a communicating unit connected to a network,
and wherein said encryption key obtaining unit obtains said encryption key information through said communicating unit.

7. The image processing apparatus according to claim 6, wherein said encryption key obtaining unit obtains said encryption key information on the basis of a TCP/IP protocol.

8. The image processing apparatus according to claim 7, wherein said encryption key obtaining unit obtains said encryption key information on the basis of an HTTP protocol.

9. An image processing apparatus having an image reading unit which reads image information from a document to obtain image data, comprising:
an encryption key forming unit which forms first encryption key information to encrypt said image data;
a first encrypting unit which encrypts said image data on the basis of said first encryption key information;
a transmission destination instructing unit which instructs a transmission destination of said image data;
an encryption key obtaining unit which obtains second encryption key information corresponding to the transmission destination of said image data instructed by said transmission destination instructing unit; and
a second encrypting unit which encrypts said first encryption key information on the basis of said second encryption key information.

10. The image processing apparatus according to claim 9, wherein said first encrypting unit executes an encrypting process according to a common key encryption system and said second encrypting unit executes an encrypting process according to a public key encryption system.

11. The image processing apparatus according to claim 10, wherein the first encryption key information encrypted by said second encrypting unit is transmitted to the transmission destination of said image data.

12. The image processing apparatus according to claim 9, further comprising an E-mail converting unit which converts the image data encrypted by said first encrypting unit into an E-mail format.

13. The image processing apparatus according to claim 9, further comprising a communicating unit connected to a network,
and wherein said encryption key obtaining unit obtains said second encryption key information through said communicating unit.

14. The image processing apparatus according to claim 13, wherein said encryption key obtaining unit obtains said second encryption key information from the transmission destination of said image data.

15. The image processing apparatus according to claim 13, wherein said encryption key obtaining unit obtains said second encryption key information on the basis of a TCP/IP protocol.

16. The image processing apparatus according to claim 15, wherein said encryption key obtaining unit obtains said second encryption key information on the basis of an HTTP protocol.

17. The image processing apparatus according to claim 9, wherein said encryption key forming unit forms said first encryption key information on the basis of pseudo random numbers.
